(19) United States
(12) Patent Application Publication
(10) Pub. No.: US 2006/0155220 A1
(43) Pub. Date: Jul. 13, 2006

(54) Method and device for current assisted massage for correction of soft tissue dysfunction in humans

(76) Inventor: Theodore F. Oslay, Ozark, IL (US)

Correspondence Address: Theodore F. Oslay;Lake Thunderhawk, 325 Dogwood Lane, Ozark, IL, 62972, US

(21) Appl. No.: 11/280,911

(22) Filed: Nov. 17, 2005

Related U.S. Application Data
(60) Provisional application No. 60/633,657, filed on Dec. 7, 2004.

(51) Int. Cl. A61H 7/00

(52) U.S. Cl. 601/21; 601/15; 601/135

(57) ABSTRACT

A simple method and device to normalize soft tissue dysfunction in humans, for use by either non-health-care professionals or professionals that have been trained in the method of using the device so as to detects and remove fibrous restrictions and scar tissue adhesions from underlying soft tissue structures and detect rope like barriers or taut muscle bands indicative of sustained muscle contractions. A set of tools used to perform the massage is comprised of an ergonomically designed handle portion, and one of two types of skin engagement portions, one for deep tissue massage and the other for superficial tissues. An alternating current is applied during the massage procedure of such configuration as to counteract the cellular effects of hypoxia and sustained muscle contraction, and facilitate healing.

### FEDERALLY SPONSORED RESEARCH

Not Applicable

### SEQUENCE LISTING

Not Applicable

### BACKGROUND OF THE INVENTION

1. Field of Invention

The present invention relates generally to a method and device which combines electrical muscle and/or sensory stimulation with massage tools to normalize soft tissue dysfunction in humans.

2. Discussion of Prior Art

There are two areas of physiology that need to be discussed in this section to understand the benefits of my invention. The first area is that of adhesion or scar tissue formation and the second area is that of a muscle's ability to contract and relax.

Adhesion formation is discussed as follows. There are three general methods in which inflammation of soft tissue areas in the body may occur. First, as a result of direct trauma, such as; direct physical blows during activity, surgical incisions or lacerations. Second, as the result of overuse or overload, such as; excessive or repetitious contraction of muscles, commonly found in overtraining or continuous activity. Thirdly, as a result of emotional factors, the most common being tension, stress, anxiety, or fear that are commonly experienced at one time or another.

An individual's body responds to inflammation by forming fibrous adhesions, or scar tissue, which is an unavoidable by-product of the natural healing process. Scar tissue forms in soft tissue areas of the body, such as; muscles, fascia, tendons, and ligaments. As scar tissue builds up, it prevents the soft tissue from lengthening and/or contracting, thereby resulting in reduced range of motion pain, and decreased stability. A state of decreased stability increases the probability of additional injury. In addition, build-up of scar tissue commonly causes a decrease in circulation which contributes to cellular hypoxia (lack of oxygen to the tissues) which in turn facilitates more fibrosis or adhesion production, which further impairs muscle function and causes pain. Resultant pain often causes the individual to perform or behave in a manner that suggests an injury still exists; despite the fact that the injury itself has healed. Therefore, it is desirable to remove the scar tissue so that the joint and surrounding tissues may achieve a greater level of performance. Scar tissue is removed by a process known as soft tissue therapy, which involves use of a therapist's or health care professional's hands to manually massage the skin over the affected soft tissue areas to release scar tissue adhesions and regain lost resting length in the tissue. This type of massage includes cross-frictional massage, deep muscle massage, whole body massage and Rolfing.

A muscle's ability to contract and relax is directly dependent on blood flow in and out of an area Blood flow into an area carries nutrients and oxygen that it can make use of while blood flow out of an area allows removal of carbon dioxide and waste products generated by its present level of cellular metabolism. Further, muscle function has only three options concerning movement; it can lengthen, it can shorten or it can lock into place, preventing either motion from occurring. A brief summary of the mechanism by which the sustained contraction component of the soft tissue dysfunction develops following trauma, overtraining and emotional distress is as follows:

1. Rupture of Sarcoplasmic Reticulum (The cell wall of muscle fiber ruptures)

2. Release of Ca++ Ions (Calcium ions normally stored are unavoidably released)

3. Increased Muscle metabolism (State of sustained contraction)

4. Sarcomere Shortening-Contracture (State of sustained contraction)

5. Local Hypoxia/Ischemia (Cell undergoes oxygen depletion/deprivation)

5. Failure of Sarcoplasmic Ca++ Pump & Lack of Adequate Supply ATP (Energy)

Essentially, under these circumstances this contraction is sustained indefinitely, using vast amounts of energy (ATP) in which this unavoidable physiological cycle maintains itself. This cycle is well established and referred to in the literature as the Energy Crisis Component Theory. Introduced in 1981, and since validated, (Simons D G, Travell J G: Myofascial trigger points, a possible explanation. Pain 10; 106-109, 1981.), and recently updated (Mense S: Referral of muscle pain: new aspects. Am Pain Soc J 3:1-9, 1994), and (Simons D G: Referred phenomena of myofascial trigger points, Chap. 28. In: Pain Research and Clinical Management: New Trends in Referred Pain and Hyperanalgesia, Vol. 27.)

Sustained muscle contraction is a critical component of soft tissue dysfunction and must be corrected in addition to adhesion or scar tissue removal; otherwise complete resolution of a soft tissue dysfunction can and will not be fully achieved.

Review of prior art demonstrates partial solutions to problems my invention solves. The following examples pertain to the adhesion or scar tissue formation component of soft tissue dysfunction.

Improvement in the prior art has been a use of tools to overcome certain downfalls of non-tool assisted massage. For example, Sevier et al. U.S. Pat. No. 6,254,555 developed a hand held tool which Graston U.S. Pat. No. 5,366,437 cites improvements over. Use of tools in soft tissue massage is a noteworthy improvement however, a number of limitations still remain in the existing processes. Correction of adhesion formation is only one part of a complete resolution to soft tissue dysfunction. One limitation is a requirement of a detailed functional examination based on a differential analysis of passive and contractile tissue is required as an integral part of the overall treatment process. This type of examination requires a working knowledge of anatomy, physiology and functional movement of joint structures which must be mastered prior to effectively applying these types of treatment systems or processes. Further, these techniques are difficult to learn and routinely use on routine patients in a limited amount of time. This requirement limits who has the ability or desire and environment to apply the entire process in a manner in which it was intended, therefore, many practitioners and therapists modify the system to achieve results that are not as good as the intended process, but still better than they had without some modification of it, and many semi-professional technicians find the process too complicated to learn and use.

A simple but recent attempt at a massage tool that would ease the pressure on the therapist's hands and provide additional leverage for reaching areas that exhibit muscle contractions or knots can be seen in Szabo, U.S. Pat. No. D456,909 S, that does not specify use and does not involve current of any kind.

Another commendable attempt at improving existing methods for normalizing soft tissue dysfunction, (without the use of massage tools), is seen in Leahy U.S. Pat. No. 6,283,916, in which an expert method for non-surgical treatment of soft tissue lesions includes placing a contact point near the lesion and causing the patient to move in a manner that produces a longitudinal sliding motion of soft tissues, e.g., nerves, ligaments, and muscles, beneath the contact point. For example, a key principle of this particular invention is manipulation of soft tissues in cooperation with active or passive motion by a patient or subject, with active motion most preferred, possibly altering the success of a complicated treatment regimen of this type. Additional considerations would be in certain cases involving a certain percentage individuals that, for whatever reason, would resist treatment rather than participate in it, which would make the procedure ineffective or at best, less than optimally effective.

Yet another similar technique is seen in Feero U.S. Pat. No. 5,501,657, a method of alleviating carpal tunnel syndrome. Many of the same problems that exist with systems that use massage tools are inherent in systems that do not use tools; unfortunately many of the problems are magnified.

These types of systems that have been examined specifically identify medical practitioners to implement treatment, which is consistent with other systems reviewed that specify professionals to learn and apply their systems. This requirement again limits who has the ability and desire to apply the entire process in the manner in which it was intended. As in other systems, many practitioners and trainers will modify these systems to achieve results that are not as good as the intended process, but still better than they had without some modification of it, which would restrict capable non-professional assistants such as EMT's from learning the procedures.

The following examples pertain to the sustained contraction component of soft tissue dysfunction. The art is abundant with examples of electrotherapy methods and equipment, known by a variety of names often dependant on the specific nature of treatment regimens involved. Known designations include MCT (microcurrent therapy), MENS (minimal electrical non-invasive therapy), TENS (transcutaneus electrical nerve stimulation) and EMS (electrical muscle stimulation). These therapies have been and continue to be used in the treatment and/or management of pain and conditions related to muscles and associated structures. According to most authorities, the acronym TENS refers to transcutaneus electrical nerve stimulation, a procedure where a relatively small electrical current is passed across the skin through electrode pads attached to the skin. The term TENS is generally reserved for those small portable electrical units that patients wear to control pain or to cause muscles to contract.

The prior art illustrates numerous attempts to find a system that will allow simple, accurate, reproducible systems or procedures to normalize soft tissue. Another such attempt can be seen in Law et al U.S. Pat. No. 5,938,690 and Fowler et al U.S. Pat. No. 5,370,672, which use computer based systems to increase performance and effectiveness. Another such attempt to diagnose and treat is seen in Marcus, U.S. Pat. No. 6,432,063 B1 utilizing electric stimulus, specifically a neuromuscular stimulator.

Yet another area in the prior art for pain related to soft tissue can be seen in Mackey U.S. Pat. No. 5,423,877 in the application of implants into the subject. A less invasive method involves electro acupuncture of which there is much art, with the following examples given; Gruzdowich U.S. Pat. No. 6,567,695 an electro-acupuncture device for controlling nausea, and Grey U.S. Pat. No. 6,535,760 B1 electro-acupuncture method to relieve premenstrual syndrome. As demonstrated, the common downfall for attempts at normalization of soft tissue dysfunction and the related signs and symptoms thereof in the existing art is the lack of the necessary pressure to affect adhesions in deeper tissues, combined with a distinct set of current settings that result in a more complete resolution of soft tissue dysfunction. Prior art examples from a wide variety of electrotherapy references include Sporer, U.S. Pat. No. 5,387,231 which describes an electrotherapy method and Wing U.S. Pat. No. 4,180,079 and Fowler, U.S. Pat. No. 5,370,672 and Silberstone et al. U.S. Pat. No. 5,052,391. The common denominator in all of these methods and devices is an absence of deep tissue massage tools in any application of current. Further it is established in the prior art to make use of either alternating or direct currents for electrotherapy treatment; however, a number of other properties of the electrical stimulus to be used, including polarity, voltage magnitude, current magnitude, and frequency can have a significant impact upon the efficacy of the treatment.

Yet another example in the prior art Fulkerson, et al U.S. Pat. No. 4,738,250 which discusses the application of a bipolar, low frequency wave form through spaced apart electrodes, across a damaged area of living animal tissue so as to increase the metabolic activity of the viable ceus in the area and hence to increase healing. This particular application lacks any significant pressure while applying the current and specifically cautions the use of force while applying current, a misconception in my opinion, because pressure is crucial to the healing of soft tissue dysfunction. The inventor further discusses the result of current on ATP synthesis, which is very solidly established in the past and current literature. In addition to the ATP synthesis, the effects of current are that as to stimulate metabolism, protein synthesis, an accelerated membrane transport system and the increase in the production of collage. In conclusion while the inventor discourages the use of pressure in the application of current, he establishes in the literature many of the benefits that current has on the body to accelerate healing of soft tissue.

There have been other commendable attempts to combine current and mechanical massage illustrated in McCall, U.S. Pat. No. 4,267,838 and Dohring, U.S. Pat. No. 4,037,590. However, the amount of pressure and manner of application are not sufficient to break up adhesions or scar tissue, nor is a current specified other than “mild.”

### OBJECTS AND ADVANTAGES

The present invention overcomes the aforementioned problems and disadvantages in numerous areas; however, a this invention demonstrates a breakthrough in treatment of soft tissue dysfunction by combining effective parameters of current applied to the subject through a new design of massage tools that facilitates deep and superficial soft tissue massage, raises clinical results to greater levels of achievement.

An object of the invention provides an improvement over existing systems to treat soft tissue dysfunction and applies those improvements for treatment of humans.

Another advantage of the current assisted tool is that it corrects the sustained muscle contraction component of the soft tissue dysfunction that was not addressed by non current assisted massage.

Another important advantage of this combination of currents and tools is the time spent applying treatment is reduced because of the tissue's response to this unique method and device. As stated earlier in prior art, the increase in ATP synthesis, the accelerated membrane transport system and the increased production of collagen fibers while incorporating a manual pressure to break up the adhesion component of the dysfunction.

A further advantage of the invention is the ability and the opportunity for the motivated non-professional acting under supervision (where state law allows) to be able to quickly learn and apply the deep and superficial massage system effectively. This is important because many Medical Practitioners are often unaware of non-invasive treatments offering higher success rates and fewer traumas to their patients than can be obtained from surgical intervention, injections, and restricted activity.

Tool design is another feature of the invention that simplifies massage tools into two basic types; one for deep tissue massage and the other for all other soft tissue areas, whereby skin over underlying and affected areas is massaged with said tools in order to apply a current in such a manner as to sufficiently locate, loosen, break up, and remove fibrous scar adhesions from the impaired soft tissue area and interrupt and correct the sustained contraction component of the soft tissue dysfunction.

In addition to simplified tools, there is a user friendly ergonomic design that is a dramatic improvement over existing tools and substantially reduces effects of physical demand on the upper extremity, wrist and hand of an individual performing the current massage. This was an important and necessary improvement as the force and position of the upper extremity during treatments continuous treatment schedules found in many workplace or office settings.

Another benefit for the user of the massage system is the ease of finding abnormalities quickly and efficiently because the improved tools act, just like a stethoscope amplifies heart sounds, to amplify the presence of adhesions and sustained muscle contractions within the soft tissue being evaluated.

A very important advantage of my invention is that the current applied through the deep and superficial massage tools causes the soft tissue dysfunction to resolve much quicker than if the treatments of tool assisted massage and electrical current applied to soft tissue were applied separately. This is because the correct current component triggers ATP synthesis which dramatically increases the effectiveness of soft tissue massage. These and other objects of the invention as well as other advantages thereof can be further comprehended by reference to the following descriptions and claims.

### SUMMARY

The present invention overcomes the aforementioned problems for deep and superficial tissue massage, by providing a set of tools that apply an electric current to both deep or superficial tissues of the soft tissue area of the patient while detecting and removing fibrous restrictions and scar tissue adhesions from underlying soft tissue and detecting rope like barriers or taut muscle bands indicative of sustained muscle contractions.

### BRIEF DESCRIPTION OF THE DRAWINGS

FIG. 101 shows the superficial massage tool referred to as the WAND.

FIG. 102 shows the deep massage tool referred to as the PROBE.

FIG. 301 shows the TENS Unit (diagram meant only to represent an alternating wave current generator, not representing the actually design of the unit) providing Neurosensory Current.

FIG. 401 shows the TENS Unit (diagram meant only to represent an alternating wave current generator, not representing the actually design of the unit) providing Neuromuscular Current.

FIG. 1 is a lateral perspective picture of a human elbow joint; showing a superficial massage tool, in accordance with the invention, engaging scar tissue that has built up on the ligament at the point of insertion to the radius.

FIG. 2 is a lateral perspective drawing of the elbow joint shown in of FIG. 1, particularly showing layers of fibrous scar tissue adhesions and their attachment to the ligament;

FIG. 3 is a view similar to that shown in FIG. 1, except that the deep tissue massage tool massage is being used in accordance with the invention, engaging a sustained muscle contraction in the belly of a muscle above the patella;

FIG. 4 is a view of the stifle joint of FIG. 1, particularly showing taut muscle fibers and adhesion nodules in the muscle above the elbow joint;

FIG. 3 is a view similar to that shown in FIG. 1; except that the scar tissue is shown being broken up and sustained muscle contraction has been resolved as a result of repeated engagement with the tools shown in FIGS. 1A and 2A;

### DETAILED DESCRIPTION

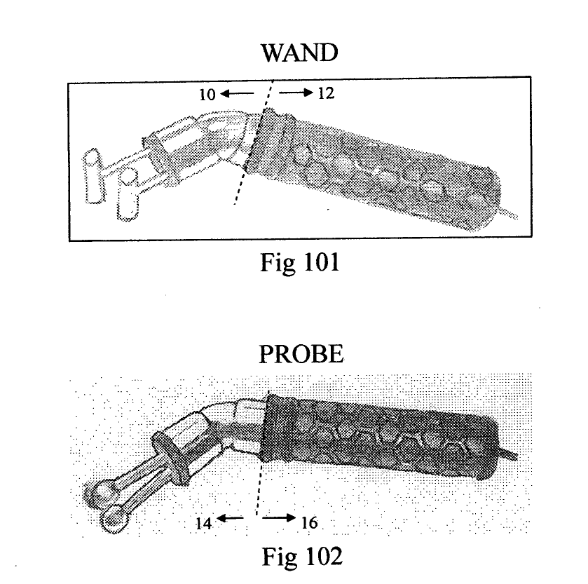

### FIGS. 101-113—Preferred Embodiment of Device

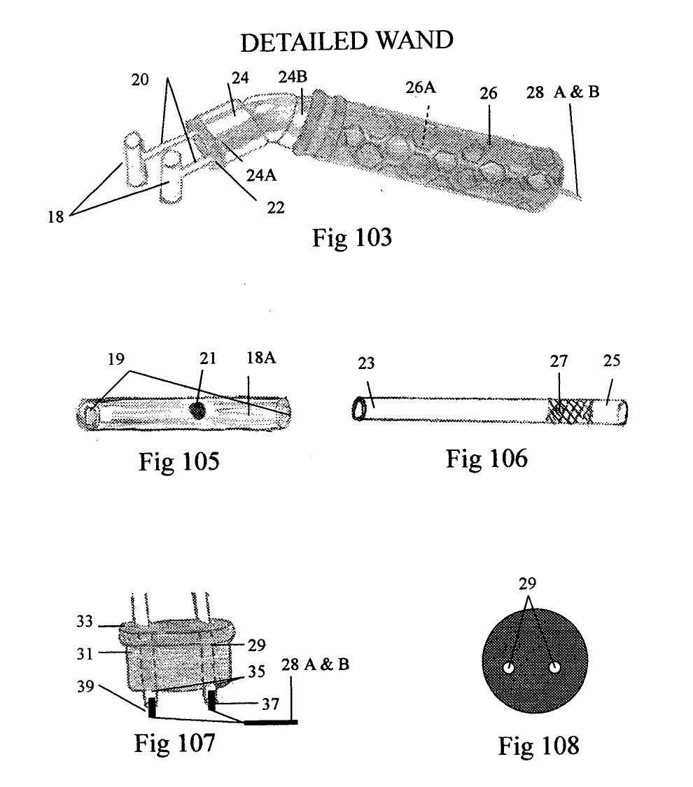

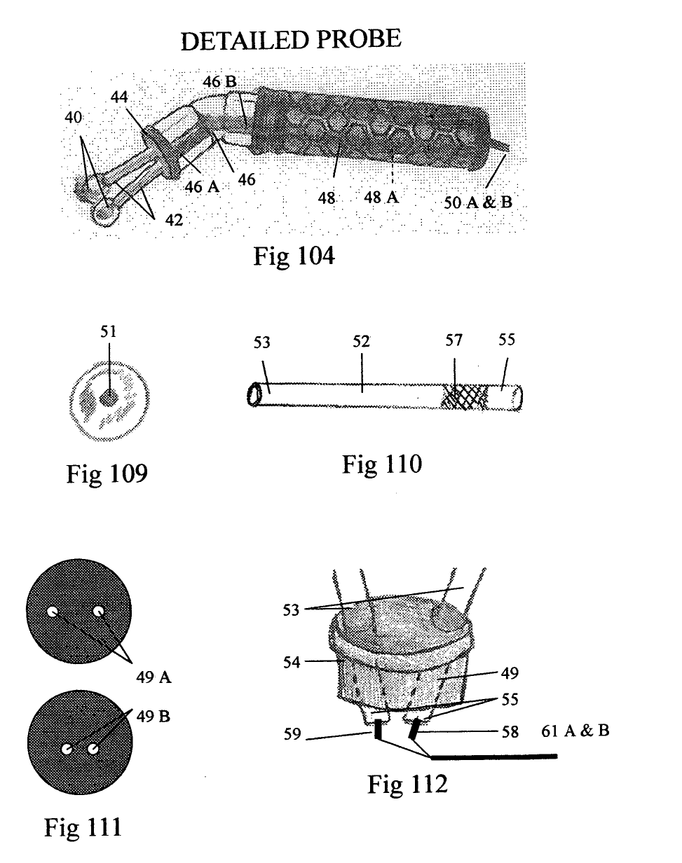

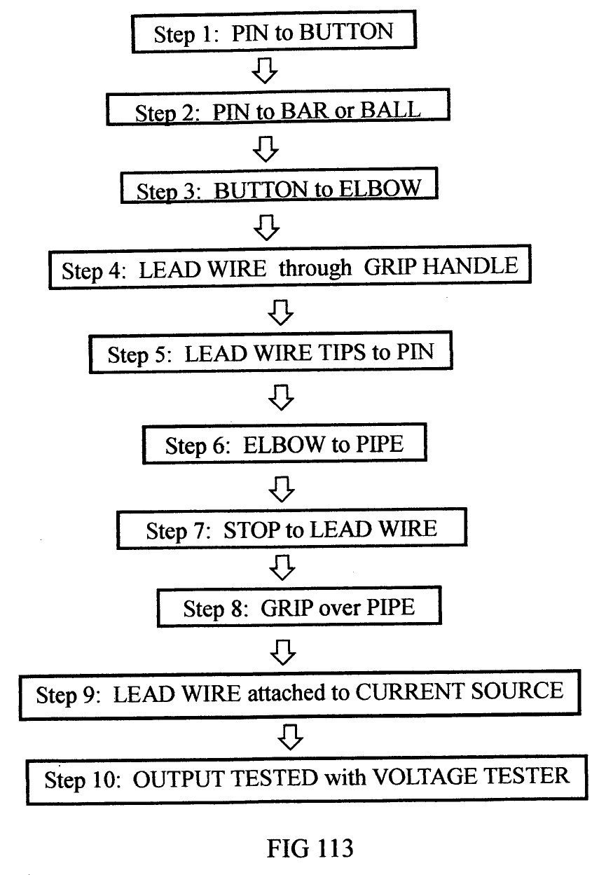

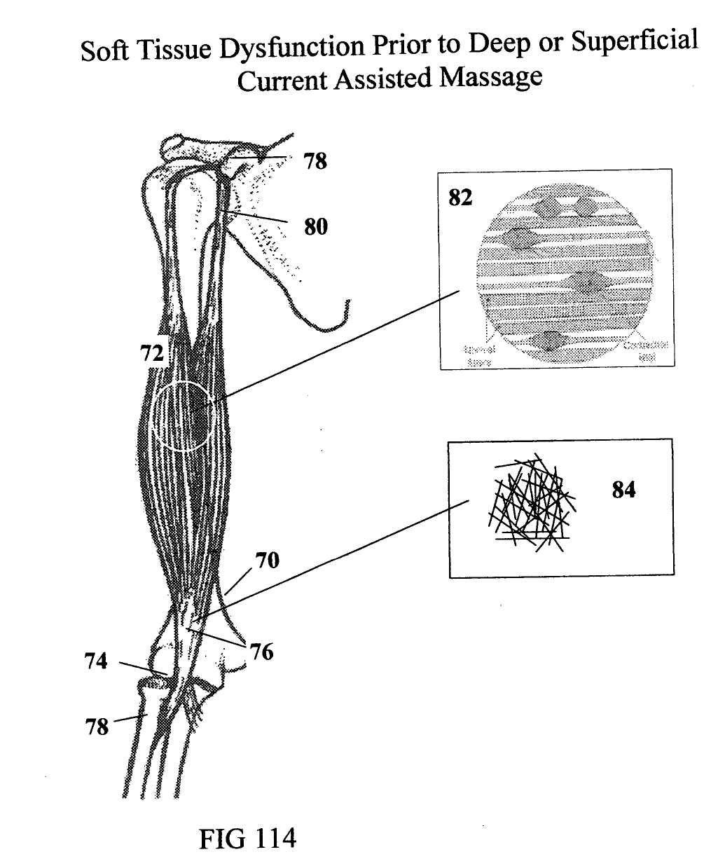

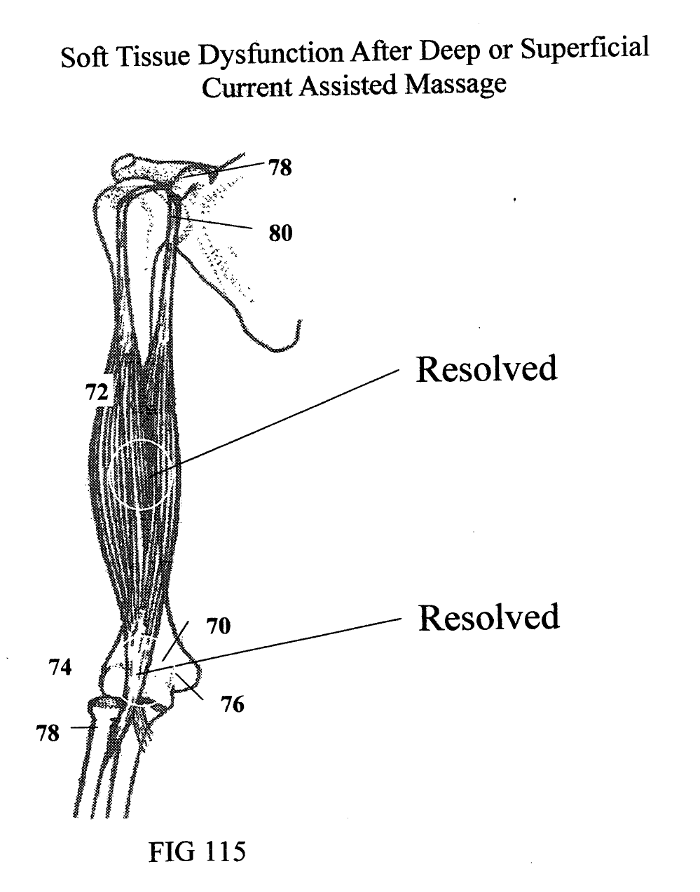

As can be seen in FIG. 101 and FIG. 102, the wand and the probe differ structurally in the tip portion of the invention. The tip portion of the wand or probe is the portion of the device that makes contact with the subject's skin and deeper tissues during the massage process.

The tip portion of the wand is shown in FIG. 101 as number 10 and the handle portion is referred to as number 12 whereas the tip portion of the probe is shown as number 14 and the handle portion is labeled as number 16.

The tip portion of the Wand labeled as FIG. 101, number 10 is comprised of four basic parts; as can be seen in FIG. 103, (18) as the bars, (20) pins, (22) button, and (24) neck. The handle portion of the Wand labeled as FIG. 101 (12) is comprised of two basic parts; as can be seen in FIG. 103 (26) as the grip which fits over (26A) inner handle and (28) as the cord, which is comprised of two separate wires, referred to in FIG. 107 as (28A and 28B). The tip portion of the Probe labeled as FIG. 102, (14) is also comprised of four basic parts; as can be seen in FIG. 104, beginning with (40) balls, (42) pins, (44) button, and (46) as the neck also discussed in further detail in FIG. 112. The handle portion of the Probe labeled as FIG. 104 is comprised of two basic parts; as can be seen in FIG. 104 (48) as the grip which fits over (48A) inner handle and (50) as the cord, which is comprised of two separate wires, referred to in FIG. 107 as (50A and 50B).

The tip of the Wand FIG. 101 is constructed in the following manner. As can be seen in FIG. 105 one bar (of two) is shown labeled as (19), corresponding to the number 18 in FIG. 103, is made of 5/16 inch grade 303, stainless steel stock that is cut to three inches in length. The ends of the bars are turned on a lathe to give the bars smooth, rounded edges FIG. 105 number 19 so as not to scratch or irritate the subject's skin during the massage. A 5/16 inch hole is drilled into the center of the bar (21) approximately 118 inch deep as seen in FIG. 105. The next step in constructing the tip of the wand involves the pin detailed in FIG. 106, referred to as number 20 in FIG. 103. The hole drilled in the bar FIG. 105 (21) will allow the bar end of the pin FIG. 106 (23) to be securely attached to the bar with an adhesive that allows conductivity, or a silver soldering process. If silver soldering is used, the parts must be buffed afterwards for appearance, due to heat discoloration. The other end of the pin (25) is inserted into the button referred to as (40) in FIG. 103. The button end of the pin has a size 20 knurl, ¼ inch long as seen in FIG. 106 (27) so as to prevent the pins and bars to twist and loosen during the massage process. (The pins are identical for both wand and probe). In FIG. 108, a view from the top to bottom, it can be seen that the button for the wand has two 5/16^{th} inch, parallel holes (29) drilled through it. The button is comprised of 1 inch stock of ABS material, which is turned on a lathe so as to fit tightly in the elbow portion of the handle as seen in FIG. 103 (24). This ABS plastic dissipates static electricity, and has exceptional insulating properties. This allows the pins to be isolated from each other as they pass through the button. Finally, ABS plastic is designed to be washed down regularly and is compliant with one or more of these standards: Food and Drug Administration (FDA), U.S. Department of Agriculture (USDA), National Sanitation Foundation (NSF) or 3A Sanitary Standards and Accepted Practices (3A). This allows for safe, frequent cleaning of the equipment between treatments. As also seen in FIG. 107, the pins are pushed into the button to allow the button end (25) of the pin to be inserted into the hole drilled in the button so as to extend through the button and as seen in FIG. 106 (25) in this view being visualized from the outside looking in and situated along the dotted lines extending from top to bottom, so that a ⅛^{th} of an inch of the button end of the pin (35) extends out of the bottom of the button (31) as seen in FIG. 107. This extension will allow each of the two lead wire tips, one positive FIG. 107 (37) and one negative (39) as first shown as one combined wire in FIG. 103 (18) to be connected securely to the pins during the final assembly process, as seen in FIG. 113 as a flow chart process. As seen in FIG. 103, there are two ends to the elbow (24), one to receive the button (24A) and one to receive the handle (24B). The elbow is chrome plated prior to the final assembly takes place. As referenced in FIG. 103, the pipe is a piece of copper tubing (26A) that is approximately 4 and ½ inches long. Also seen in FIG. 103 is the grip (26) which fits tightly over the pipe. Finally the cord the conducts current to the instrument is shown as 28A & B) because there are two wires combining together as a durable and safe cord.

The tip of the Probe FIG. 102 (14) is constructed in the following manner. The tip of the probe FIG. 104 is constructed in the following manner. The (40) balls are made of grade 303, stainless steel, and are ½ inch diameter. A 5/16 inch hole (51) is drilled into the center of the ball approximately ⅛ inch deep as seen in FIG. 109. The next step to construct the tip of the probe which uses the (52) pin detailed in FIG. 104. The hole drilled in the ball will allow the (53) ball end of the pin to be securely attached to the (40) ball(s) with a conductive adhesive, or silver soldering process. If silver soldering is used, the parts must be buffed afterwards for appearance, due to heat discoloration. The other end of the (55) pin, (also referred to as the button end), is inserted into the button labeled FIG. 110. Also in FIG. 110 the button end of the pin has a size 20 knurl, ¼ inch long (57) so as to prevent the pin, and attached ball to twist and loosen during the massage process, (the pins are identical for both wand and probe). As seen in FIG. 111 the button for the probe has two, 5/16^{th} inch holes drilled through it so as to make a 14 degree angle, with the ball end of the pins (49A) are wider apart than the button ends of the pins (49B), with the hole itself being referred to as 49 as seen conceptually in FIG. 112. The button is comprised of 1 inch stock of ABS material, which is turned on a lathe so as to fit tightly in the (46A) elbow portion of the (48) handle a seen in FIG. 104. This plastic dissipates static electricity, and has exceptional insulating properties. This allows the pins to be isolated from each other as they pass through the button. Finally, ABS plastic is designed to be washed down regularly and is compliant with one or more of these standards: Food and Drug Administration (FDA), U.S. Department of Agriculture (USDA), National Sanitation Foundation (NSF) or 3A Sanitary Standards and Accepted Practices (3A). This allows for safe frequent cleaning of the equipment between treatments. These holes FIG. 112 (49) will allow the (55) button end of the Din to be so that a ⅛^{th} of an inch (55) extends out of the bottom of the button (54). This extension will allow the (58 & 59) lead wire tips to be connected to the pins during the final assembly process. As seen in FIG. 104, there are two ends to the elbow (24), one to receive the button (24A) and one to receive the handle (24B). The elbow is chrome plated prior to the final assembly takes place. As referenced in FIG. 104, the pipe is a piece of copper tubing (48A) that is approximately 4 and ½ inches long. Also seen in FIG. 104 is the grip (48) which fits tightly over the pipe. Finally the cord the conducts current to the instrument is shown as (61A & B) because there are two wires combining together as a durable and safe cord.

As also referenced as FIG. 113, the following information shows the assembly process in steps 1 though 10.

Step 1: Pins are inserted into the button and secured.

Step 2: Pins are inserted into the bars or balls and secured.

Step 3: Lead wire is pushed through bottom of grip handle.

Step 4: Lead wire tips are inserted into the pin and secured.

Step 5: Button is inserted into elbow and secured.

Step 6: Pipe is inserted into elbow and secured.

Step 7: Stop attached to lead wire

Step 8: Grip inserted over pipe and secured.

Step 9: Lead wire connected to therapy unit.

Step 10: Output tested with voltage tester.

### FIGS. 1-6 Preferred Embodiment of Method

FIGS. 114 depicts through simple drawings the existence of adhesion formation and sustained contractions as they occur in the human body, using an illustration of the arm and elbow joint for sake of illustration, but not limiting the concept to that area Referring now to the drawings, and in particular to FIG. 114, there is shown a view of a human arm having a humerus 70 and a biceps muscle (72) that is attached to tuberosity of the radius (74) by tendon (76). Similarly, there is shown a coracoid process of the scapula (78) that is connected to superior portion of the biceps muscle (74) by a tendon (80), which is subject to a great amount of stress and potential injury.

Also in FIG. 114 is shown adhesion formation within a tendon insertion (84) and sustained muscle contractions (82) containing taut, inflexible bands of muscle that contain knots (82) within the muscle belly. Once soft tissue is injured, those areas set an artificial ceiling on its ability to recover, heal and perform by restricting blood flow in and out of the area.

As best shown in FIG. 114, scar tissue (42) is made up of individual fibers bound together in an unorganized manner. As scar tissue (82) comes into contact with bone, in this case radial bone (78), it becomes hard and takes away flexibility in the lower elbow joint. The scar tissue shown in FIG. 114 is shown in an early phase. In more severe cases, scar tissue advances around the joint capsule and adheres on other adjacent soft tissue areas. It should be noted that the present invention is designed to remove scar tissue in all degrees of advancement, and not limited to early stages. As best shown in FIG. 114, the sustained muscle contraction (82) of the soft tissue dysfunction component which develops from decreased blood flow decreases the performance of the joint and restricts motion, often causing pain. These taut fibers and nodules in the belly of the biceps muscle (82) which developed from sustained muscle contractions shown in FIG. 114 are also shown in an early phase. In more severe cases, cellular hypoxia has accelerated scar tissue formation into the fascia surrounding muscles, and caused the fibers to shorten and harden. It should be noted that the present invention is designed to remove scar tissue and taut fibers with nodules in all degrees of advancement, and not limited to early stages.

Resolution of the soft tissue dysfunction as seen in FIG. 114 has been corrected after the application of the current assisted deep and superficial massage as shown in FIG. 115. It should be noted that the present invention is designed to remove scar tissue in all degrees of advancement, and not limited to early stages, and is described in further detail in the following narrative on the method of application of my invention.

The operation of the device on an affected area of soft tissue of an individual patient begins by setting (to tolerance) a current necessary for treatment with either the wand and/or probe. In order to perform current assisted deep or superficial soft tissue massage utilizing the tools according to the present invention, the affected soft tissue area is first topically treated with a conductive lubricant such as a quality grade of ultra sound gel. The term “soft tissue” generally refers to a muscle, ligament, or tendon, or any combination thereof It is noted that the tools of the present invention may be used on any part of the body in which a soft tissue injury has occurred and scar tissue has been built up and sustained muscle contractions are present as a result of the healing process. The particular soft tissue area illustrated herein, an elbow or knee joint, is merely illustrative of one possible application of the tools of the present invention. Further, the illustration of treating an human body part in FIG. 114 is merely illustrative of one possible application of the method and device of the present invention, and could apply to any soft tissue part on a human.

It should be noted that in FIG. 114, other soft tissue structures in the area of the elbow and shoulder joints have been omitted for the sake of simplicity in the following description. A small amount of conductivity gel is applied to the area being treated. There is no need to remove or shorten the hair of any person in order to perform the treatment. The wand or probe is then placed against the skin with enough pressure so that there will be a slight indentation of the skin where the instrument is held to initially set the level of the current. Applied pressure should not be painful to the person, and his or her response will allow that the proper level or amount of pressure (to tolerance) is used. Next, the current is slowly increased until one of two things occurs; 1. The person acknowledges the current by saying something, or a shift of his or her body lets it be known they feel it, or 2. The muscles under the area of the probe or wand begin to twitch. Once this is done, the detection portion of the treatment may begin.

The wand is used in a manner much like using a paint scraper, going very slowly so as to feel the restriction and gently coaxing it loose. The pressure exerted is enough to bunch up the skin in directly in front of the bars in the direction of the movement. An integral part of the treatment process is the exploratory phase of the targeted area of treatment. This entails passing the wand over an area in multiple directions, all of which originate from the center and go outward. A good analogy would be to picture a pie cut into pieces. The center portion of the pie is the starting area for the direction of the pressure of the wand. Each “slice” would be the direction of the wand with pressure in a fan like area extending outward. Typically five or six strokes or passes would be sufficient to find the usual two or three directions that reveal a different feel in the texture and thickness of the deeper tissues as magnified by the wand. The wand acts just like a stethoscope to amplify all of the abnormal gritty, sand-like restrictions that are not found in normal, healthy tissue. Such scar tissue is often undetectable by merely using one's hands alone. This increased ability to detect abnormal restrictions in the targeted area, allow a relatively inexperienced individual to quickly become proficient in the ability to find the restrictions needing to be corrected

Once detected, the restrictions are treated by applying slow, steady pressure in the same manner and direction that was used to find them. As the pressure is exerted, there will be a noticeable difference as the restrictions are broken up and dissipated. The treatment is finished when a substantial difference as been detected as compared to the texture and feel of the tissue from the initial passes of the wand.

Whereas, the wand is used in correcting superficial soft tissue dysfunctions in broader flatter muscles and their attachments to bone where adhesions are more superficial in nature, the probe is used to detect and correct restrictions and sustained muscle contractions found in tissue at deeper levels. A small amount of conductivity gel is applied to the area being treated. There is no need to remove or shorten the hair of any animal in order to perform the treatment. The wand or probe is then placed against the skin with enough pressure so that there will be a slight indentation of the skin where the instrument is held to initially set the level of the current. Applied pressure should not be painful to the animal, and its response will allow that proper amount to be used. Next, the current is slowly increased until one of two things occurs; 1. The person acknowledges the current by saying something or he or she shifts its body and moves a bit or 2. The muscles under the area of the probe or wand begin to twitch. Once this is done, the detection portion of the treatment may begin. The operation of the device on the person is as follows for the initial setting of the current in preparation of treatment with the wand or probe: A small amount of conductivity gel is placed in the area being treated. The probe is then placed against the skin with enough pressure for the person to feel the tension from the contact. The pressure should not be so much that when applied it hurts and/or the animal pulls away from the contact of the wand or probe on the skin. Usually, there will be a slight indentation of the skin where the instrument is held to initially set the level of the current. Next, the current is slowly increased until one of two things occurs; 1. the person audibly acknowledges the current, or a shift of body or body part occurs, or 2. The muscles under the area of the probe begin to twitch Once this is done treatment may begin with the probe.

The probe is used in a manner much like a compass scribing a circle. The pressure exerted on the balls is enough to bunch up the skin in directly in front of the balls in the direction of the movement. An integral part of the treatment process is the exploratory phase of the targeted area of treatment. This entails placing the left ball, (with more pressure placed on the left ball than the right), so as to be able to “scribe” or move the right ball in first a clockwise motion, and then a counterclockwise motion. As the ball is moved in the arc of the circle of the immediate area being examined, there will be an enhanced ability by the individual performing the movement to feel taut fibers or cords in the tissue that are tighter than others. A good analogy would be to picture these abnormal cords or fibers like one or more guitar strings that are tighter than the others on the same instrument. Restrictions are revealed when the balls “click” or “pluck” a taut fiber, as they cross perpendicularly or directly against the direction of the fibers or band of tissue being examined. The probe also acts just like a stethoscope to amplify all of the abnormally tight fibers, knot-like restrictions within the tissue being examined. These restrictions are not found in normal, healthy tissue. This increased ability to detect abnormal restrictions in tissue allows an inexperienced individual to quickly become proficient in the ability to find the restrictions needing to be corrected.

Once detected, the restrictions are treated in the following manner; the balls are placed against the taut fiber(s) so that both balls are exerting equal pressure directly perpendicular to that tight band or fiber. Then one of the balls is slipped up and over the taut fiber so that a ball is now on each side of this fiber. This allows the treatment to be exactly on target because the probe is guided by the direction of the tight band or fibers. The pressure is exerted along the direction of the fibers. This pressure exerted is exactly the opposite of the direction used in finding the taut fibers. As the pressure is exerted, there will be a noticeable difference in the feel of the tissue as the restrictions are broken up and dissipated. The treatment is finished when a substantial difference has been detected as compared to the texture and feel of the tissue from the initial passes of the probe.

Once the restrictions have been found with the assistance of either the wand or the probe, and the treatment follows the directions described above, the treatment will be specific so as to provide a rapid response and significant recovery. Areas of involvement proximal or distal to the target area are also essential, and must be treated. The wand and probe are essential to this invention because manual palpation, (feeling with hands and fingers), will not help locate many of these areas, thereby necessitating the aid of these tools. The technique also enhances manual treatment currently practiced by trained professionals. This invention would expand their effectiveness in many ways.

The probe causes an increased ability to feel the gritty adhesions, or washboard like knots within the deeper musculature. This massage is performed until the knots and adhesions have dissipated. These treatments continue until there are no restrictions or adhesions detected during the initial phase of treatment with either the wand or probe.

In addition, the handle portions of the tools may be modified as needed to allow the trainer more leverage as well as to permit the trainer to reach soft tissue areas which may otherwise be difficult to reach and apply soft tissue therapy thereto.

It will be appreciated that the preceding is presented by way of illustration only, and not by way of any limitation, and that various alternatives and modifications may be made to the illustrated embodiment without departing from the spirit and scope of the invention.

What is claimed is:

1. A method for training others in use of a system protocol to treat humans, afflicted with soft tissue dysfunction, by detecting and correcting restrictions of fibrous scar tissue adhesions and/or taut fibers of sustained muscle contractions, from underlying soft tissues by the use of a current assisted massage tool comprising:
a tip portion of the current assisted massage tool which is the portion of the device that makes contact with the person's' skin and deeper tissues during the massage process, a handle portion of the tool which is held and operated by the treating individual, and the neurosensory/neuromuscular current generating portion of the device.

2. The tool of claim 1, wherein the tip portion consists of two parallel horizontal rods which contact the animals' skin.

3. The tool of claim 1, wherein the tip portion consists of two bifurcated rods with spherical balls attached at the distil end which contact the person's skin.

4. The tool of claim 1, wherein the tip portion that contacts the person's skin is made of stainless steel.

5. The tool of claim 1, where the handle portion remains the same for all tip variations.

6. The tool of claim 1, wherein current applied by said tool is sinusoidal.

7. The method as set forth in claim 1 wherein said step of training others to use said system protocol consists essentially of training others to manually manipulate an anatomical area of said person with current assisted massage tools to eliminate said soft tissue dysfunction.
